(19) United States
(12) Patent Application Publication
(10) Pub. No.: US 2021/0329910 A1
(43) Pub. Date: Oct. 28, 2021

(54) COMPOSITION FOR STABILIZING AT LEAST ONE AGROCHEMICAL ACTIVE INGREDIENT

(71) Applicant: Bayer CropScience LP, St. Louis, MO (US)

(72) Inventors: Justin ELDRIDGE, Creedmoor, NC (US); Fred ROSA, Wake Forest, NC (US)

(21) Appl. No.: 16/624,854

(22) PCT Filed: Jun. 8, 2018
(86) PCT No.: PCT/US2018/036602

§ 371 Date: Dec. 19, 2019

Related U.S. Application Data
(60) Provisional application No. 62/523,423, filed on Jun. 22, 2017.

(51) Int. Cl. A01N 25/04; A01N 25/22; A01N 43/653

(52) U.S. Cl. CPC A01N 25/04; A01N 43/653; A01N 25/22

(57) ABSTRACT

The present invention provides a composition for stabilizing at least one active ingredient. The composition comprises at least one active ingredient and at least two of the following: a polycarboxylic acid polymer or a salt thereof, an anionic surfactant, and a wax agent. The composition has a retention of 2.4% or less when conducting a wet sieve analysis in accordance with CIPAC MT 185 and using a 100 mesh size sieve.

### BACKGROUND

As agricultural formulations and compositions are prepared, they may be stored for a substantial period of time prior to use. As a result, it is important to provide agricultural formulations and compositions that are chemically and/or physically stable during this time. By doing so, the utility of the formulations and compositions can be maximized.

Generally, active ingredients are not employed by themselves. Instead, more commonly, agricultural formulations and compositions contain an active ingredient in combination with multiple components including, but not limited to, solvents, safeners, surfactants, dispersion aids, pigments, etc. In general, these additional components allow for the formulations and compositions to be employed in order to achieve optimal efficacy and efficiency. Because there is a constant desire to improve such efficacy and efficiency, the components of such formulations and compositions are continually changing. In some situations, even additional components, such as additional active ingredients or additional active ingredient formulations, are employed in order to maximize the effect of the delivery and application of such formulations and compositions. Thus, ensuring that they remain stable and effective is an ongoing challenge.

Accordingly, there is a need to provide a composition that provides improved stability of agrochemical active ingredients.

### SUMMARY OF THE INVENTION

In accordance with one embodiment of the present invention, a composition for stabilizing at least one active ingredient is disclosed. The composition comprises at least one active ingredient and at least two of the following: a polycarboxylic acid polymer or a salt thereof, an anionic surfactant, and a wax agent. The composition has a retention of 2.4% or less when conducting a wet sieve analysis in accordance with CIPAC MT 185 and using a 100 mesh size sieve.

In accordance with another embodiment of the present invention, a method of coating a seed is disclosed. The method comprises a step of contacting the seed with a composition comprising at least one active ingredient and at least two of the following: a polycarboxylic acid polymer or a salt thereof, an anionic surfactant, and a wax agent. The composition has a retention of 2.4% or less when conducting a wet sieve analysis in accordance with CIPAC MT 185 and using a 100 mesh size sieve.

In accordance with another embodiment of the present invention, a coated seed is disclosed. The coated seed is made by contacting an uncoated seed with a composition comprising at least one active ingredient and at least two of the following: a polycarboxylic acid polymer or a salt thereof, an anionic surfactant, and a wax agent. The composition has a retention of 2.4% or less when conducting a wet sieve analysis in accordance with CIPAC MT 185 and using a 100 mesh size sieve.

Other features and aspects of the present invention are discussed in greater detail below.

### DETAILED DESCRIPTION OF THE INVENTION

Reference now will be made in detail to various embodiments of the invention, one or more examples of which are set forth below. Each example is provided by way of explanation of the invention, not limitation of the invention. In fact, it will be apparent to those skilled in the art that various modifications and variations may be made in the present invention without departing from the scope or spirit of the invention. For instance, features illustrated or described as part of one embodiment, may be used on another embodiment to yield a still further embodiment. Thus, it is intended that the present invention covers such modifications and variations as come within the scope of the appended claims and their equivalents.

Generally speaking, the present invention is directed to a composition for stabilizing at least one active ingredient, such as an agrochemical active ingredient as defined herein. The present inventors have discovered that the composition disclosed herein can increase the stability of the active ingredient(s) such that it may remain stable for a longer duration of time, such as during storage. In this regard, the present inventors have discovered that the composition disclosed herein can exhibit minimal crystal growth thereby maximizing the shelf-life of the composition. In particular, the present inventors have discovered that the amount of components necessary to stabilize the composition can be reduced in comparison to conventional compositions for stabilization.

A. Active Ingredients

As indicated herein, the presently claimed composition includes at least one active ingredient. As utilized herein, an active ingredient refers to an agrochemical active ingredient. For instance, the agrochemical active ingredient may be a biological agrochemical active ingredient, an organic small molecule active ingredient, or a mixture thereof. In one embodiment, the agrochemical active ingredient comprises a biological agrochemical active ingredient as generally known in the art. In another embodiment, the agrochemical active ingredient comprises an organic small molecule active ingredient as generally known in the art.

Accordingly, the active ingredient may be any form of pesticide. For instance, the active ingredient may be an herbicide, an insecticide, a nematicide, a miticide, a fungicide, etc. It should be understood that the active ingredient is not limited to any of the aforementioned and may include other active ingredients generally well known in the art.

In one embodiment, the active ingredient comprises at least a fungicide. In one embodiment, the active ingredient comprises at least two fungicides. In one embodiment, the active ingredient comprises at least three fungicides.

The fungicide can include any known fungicides known in the art. The fungicide agents include, but are not limited to, the following: Captan (N-trichloromethyl)thio-4-cyclohexane-1,2-dicarboximide), Thiram (tetramethylthioperoxydicarbonic diamide; also commercially available under the tradename Proseed), metalaxyl (methyl N-(2,6-dimethylphenyl)-N-(methoxyacetyl)-DL-alaninate; also commercially available under the tradename Allegiance), Fludioxonil (4-(2,2-difluoro-1,3-benzodioxol-4-yl)-1-H-pyrrol-3-carbonitril; also commercially available in a blend with mefonoxam under the tradename Maxim XL), difenoconazole (also commercially available under the tradename Dividend 3FS), carbendazim iprodione (also commercially available under the tradename Rovral®), ipconazole, mefonoxam (also commercially available under the tradename Apron XL), prothioconazole, propiconazole, tebuconazole, carboxin, thiabendazole, azoxystrobin, trifloxystrobin, fluoxastrobin, prochloraz, Oxadixyl (N-(2,6-dimethylphenyl)-2-methoxy-N-(2-oxo-3-oxazolidinyl) acetamide).

In one embodiment, the active ingredient comprises at least prothioconazole. In one embodiment, the active ingredient comprises at least metalaxyl. In one embodiment, the active ingredient comprises at least fluoxastrobin. In one embodiment, the active ingredient includes prothioconazole, metalaxyl, fluoxastrobin, or any combination thereof. For instance, in one embodiment, the active ingredient includes at least any two of prothioconazole, metalaxyl, and fluoxastrobin. In one particular embodiment, the active ingredient includes prothioconazole and metalaxyl.

The bactericide can include any known bactericides known in the art. The bactericides include, but are not limited to, the following: streptomycin, penicillins, tetracyclines, ampicillin, and oxolinic acid.

The insecticide can include any known insecticides known in the art. The insecticides include, but are not limited to, the following: pyrethroids, organophosphates, caramoyloximes, pyrazoles, amidines, halogenated hydrocarbons, neonicotinoids, and carbamates and derivatives thereof. These insecticides can include, but are not limited to, the following: terbufos, chlorpyrifos, fipronil, chlorethoxyfos, tefluthrin, carbofuran, imidacloprid, tebupirimfos, clothianidin, thiametoxam, thiacloprid, and acetamiprid.

The nematicide can include any known nematicides known in the art. The nematicides include, but are not limited to, the following: abamectin and thiodicarb.

Additionally, it should be understood that the composition disclosed herein can be employed for stabilizing a combination of active ingredients. In this regard, the composition can be employed to stabilize at least two different species, such as at least three different species, such as at least four different species of active ingredients from different pesticide classes. Additionally, the composition can also be employed to stabilize at least two different species, such as at least three different species, such as at least four different species of active ingredients from the same pesticide class. Additionally, the composition can also be employed to stabilize at least two different species, such as at least three different species, such as at least four different species from different pesticide classes and/or from the same pesticide class.

In one embodiment, the composition can be employed to stabilize at least two different species. In another embodiment, the composition can be employed to stabilize at least three different species. In another embodiment, the composition can be employed to stabilize at least four different species. In one embodiment, the species may be from the same and/or different pesticide class. In another embodiment, at least two of the species are from the same pesticide class. In another particular embodiment, the species are from different pesticide classes.

In one embodiment, the active ingredients may comprise about 40 wt. % or less, such as about 30 wt. % or less, such as about 25 wt. % or less, such as about 20 wt. % or less, such as about 17.5 wt. % or less, such as about 15 wt. % or less, such as 12.5 wt. % or less, such as about 10 wt. % or less, such as about 7.5 wt. % or less, such as about 5 wt. % or less, such as about 4 wt. % or less, such as about 3 wt. % or less of the composition.

In one embodiment, the active ingredients may comprise about 0.001 wt. % or more, such as about 0.01 wt. % or more, such as about 0.1 wt. % or more, such as about 0.5 wt. % or more, such as about 1 wt. % or more, such as about 2 wt. % or more, such as about 3 wt. % or more, such as about 4 wt. % or more, such as about 5 wt. % or more, such as about 7.5 wt. % or more, such as about 10 wt. % or more, such as about 12.5 wt. % or more, such as about 15 wt. % or more of the composition.

In one embodiment as mentioned above, the composition may comprise more than one species of active ingredients. In this regard, each active ingredient may be present in the aforementioned amounts individually or the active ingredients may be present in the aforementioned amounts in combination.

B. Polycarboxylic Acid Polymer

As indicated herein, the presently claimed composition includes at least one polycarboxylic acid polymer or a salt thereof. In one particular embodiment, the polycarboxylic acid polymer comprises a salt of a polycarboxylic acid polymer. In general, a polycarboxylic acid polymer is a polymer having multiple carboxylic acid functional groups. For instance, the monomers polymerized in the synthesis of such polycarboxylic acid contain at least one carboxyl functional group. In this regard, the carboxyl functional groups or a salt thereof are side changes of the polymer.

In one embodiment, the polycarboxylic acid polymer or a salt thereof comprises a polyacrylic acid polymer or a salt thereof. In one particular embodiment, the polycarboxylic acid polymer comprises a polyacrylic acid polymer. In another particular embodiment, the polycarboxylic acid polymer comprises a salt of a polyacrylic acid polymer (i.e., a polyacrylate polymer).

The polyacrylic acid polymer or salt thereof can be synthesized from any acrylic monomers or a salt thereof generally known in the art. For instance, the monomers may include, but are not limited to, the following: acrylic acid, methyl acrylate, ethyl acrylate, butyl acrylate, hydroxyethyl acrylate hydroxybutyl acrylate, carboxyethyl acrylate, methacrylic acid, methyl methacrylate, hydroxy butyl methacrylate, lauryl methacrylate, stearyl methacrylate, or a combination thereof. In one particular embodiment, the monomers include acrylic acid, methacrylic acid, and the like or a salt thereof.

In one embodiment, the polyacrylic acid polymer or a salt thereof may be a homopolymer or a copolymer. In one embodiment, the polyacrylic acid polymer or a salt thereof may also be polymerized from a carboxylic acid monomer as well as an ester, such as a C₁₋₄ alkyl ester, of a carboxylic acid monomer.

As indicated above, the polycarboxylic acid polymer may be a salt. For instance, the salt may be an alkali metal, an alkaline earth metal, or ammonium. Accordingly, if the salt comprises an alkali metal, the metal may be sodium or potassium. If the salt comprises an alkaline earth metal, the metal may be magnesium or calcium. Accordingly, the salt may be a sodium, potassium, magnesium, calcium, or ammonium salt. In one particular embodiment, the salt may be a sodium, potassium, magnesium, calcium, or ammonium salt. In another particular embodiment, the salt may be a sodium, potassium, calcium, or ammonium salt. In another particular embodiment, the salt may be a sodium or potassium salt. In another particular embodiment, the salt may be a sodium salt. Additionally, it should be understood that the salt may be a combination of any of the aforementioned salts.

The polycarboxylic acid polymer or a salt thereof, such as the polyacrylic acid polymer or a salt thereof, may have a weight average molecular weight of about 20,000 g/mol or less, such as about 15,000 g/mol or less, such as about 12,000 g/mol or less, such as about 10,000 g/mol or less, such as about 7,500 g/mol or less, such as about 5,000 g/mol or less to about 100 g/mol or more, such as about 500 g/mol or more, such as about 1,000 g/mol or more, such as about 2,000 g/mol or more, such as about 3,000 g/mol or more. For instance, the polycarboxylic acid polymer, such as the polyacrylic acid polymer or a salt thereof, may have a weight average molecular weight of from about 500 g/mol to about 20,000 g/mol, such as from about 1,000 g/mol to about 15,000 g/mol, such as from about 2,000 g/mol to about 12,000 g/mol, such as from about 5,000 g/mol to about 510,000 g/mol.

In one embodiment, the polycarboxylic acid polymer or a salt thereof may comprise about 10 wt. or less, such as about 7.5 wt. % or less, such as about 5 wt. % or less, such as about 2.5 wt. % or less, such as about 2 wt. % or less, such as about 1 wt. % or less, such as about 0.75 wt. % or less, such as about 0.6 wt. % or less, such as about 0.5 wt. % or less, such as about 0.45 wt. % or less, such as about 0.4 wt. % or less, such as about 0.3 wt. % or less, such as about 0.25 wt. % or less, such as about 0.2 wt. % or less of the composition.

In one embodiment, the polycarboxylic acid polymer or a salt thereof may comprise about 0.001 wt. % or more, such as about 0.005 wt. % or more, such as about 0.01 wt. % or more, such as about 0.05 wt. % or more, such as about 0.1 wt. % or more, such as about 0.125 wt. % or more, such as about 0.15 wt. % or more, such as about 0.175 wt. % or more, such as about 0.2 wt. % or more, such as about 0.25 wt. % or more, such as about 0.3 wt. % or more, such as about 0.35 wt. % or more, such as about 0.4 wt. % or more, such as about 0.45 wt. % or more, such as about 0.5 wt. % or more, such as about 0.75 wt. % or more, such as about 1 wt. % or more of the composition.

C. Anionic Surfactant

As indicated herein, the presently claimed composition includes at least one anionic surfactant. The anionic surfactant may comprise a sulfonate, a sulfate ester, a phosphate surfactant, a sulfosuccinic acid derivative, an ether carboxylate, a fatty acid derivative, a lignosulfonate (e.g., sodium lignosulfonate, calcium lignosulfonate, etc.), salts of naphthalene sulfonates (e.g., sodium salt, calcium salt, etc.), or a combination thereof.

In one embodiment, the anionic surfactant comprises a phosphate surfactant. For instance, such surfactant contains a phosphate group. In one particular embodiment, the anionic surfactant comprises a phosphate ester. In one embodiment, the phosphate ester comprises an alkyl phosphate ester, an ethoxylated and/or propoxylated phosphate ester, or a combination thereof. In one particular embodiment, the phosphate ester comprises an ethoxylated and/or propoxylated phosphate ester. In one particular embodiment, the phosphate ester comprises an ethoxylated phosphate ester.

In one embodiment, the anionic surfactant, such as the phosphate surfactant, such as the phosphate ester surfactant, comprises an ethoxylated alkyl ether phosphate having the following formula:

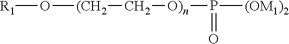

and/or an ethoxylated dialkyl ether phosphate having the following formula:

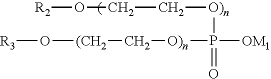

In one particular embodiment, the anionic surfactant comprises the former ethoxylated alkyl ether phosphate. In one particular embodiment, the anionic surfactant comprises the latter ethoxylated dialkyl ether phosphate. In another particular embodiment, the anionic surfactant comprises a combination of the ethoxylated alkyl ether phosphate and the ethoxylated dialkyl ether phosphate.

In the aforementioned formulae, R₁, R₂, R₃ can be identical or different and represent a linear or branched alkyl radical; a phenyl radical; an alkylaryl radical; an arylalkyl radical; n is the number of ethylene oxide groups; M1 represents a hydrogen, an alkali metal, or an alkaline earth metal.

In one embodiment, R₁, R₂, and/or R₃ are an alkyl radical. In one embodiment, the alkyl radical has from 2 to 20 carbon atoms. In another embodiment, the alkyl radical has about 2 or more, such as about 4 or more, such as about 6 or more, such as about 8 or more to about 20 or less, such as about 18 or less, such as about 16 or less, such as about 14 or less, such as about 12 or less, such as about 10 or less carbon atoms.

In one embodiment, R₁, R₂, and/or R₃ are an alkylaryl radical. For instance, the alkylaryl radical may be an alkylphenyl radical. For instance, the alkyl chain of such radical may have from 5 to 15 carbon atoms, such as from 8 to 12 carbon atoms.

In one embodiment, R₁, R₂, and/or R₃ are an arylalkyl radical. For instance, the arylalkyl radical may be a phenylaryl radical. For instance, the alkyl chain of such radical may have from 5 to 15 carbon atoms, such as from 8 to 12 carbon atoms.

In one particular embodiment, R₁, R₂, and/or R₃ can in particular be a hexyl, octyl, decyl, dodecyl, oleyl, nonylphenyl radical. In one particular embodiment, R₁, R₂, and/or R₃ can be decyl.

In one embodiment, n is from 2 to 12. In one embodiment, n is about 2 or more, such as about 3 or more, such as about 5 or more, such as about 6 or more to about 20 or less, such as about 16 or less, such as about 14 or less, such as about 12 or less, such as about 10 or less.

In one embodiment, M1 represents a hydrogen, an alkali metal, or an alkaline earth metal, or a combination thereof. In one embodiment, M1 represents a hydrogen. In one embodiment, M1 represents an alkali metal, such as sodium or potassium. In one embodiment, M1 represents an alkaline earth metal, such as calcium.

In the aforementioned formulae, ethylene oxide groups are represented. However, it should be understood that propylene oxide groups may also be employed in lieu of or in addition to the ethylene oxide groups. In such instance, n may be as defined as above.

In general, the anionic surfactant may comprise a polyoxymethylene alkyl (C8-C10) ether phosphate, a polyoxyethylene tridecyl ether phosphate, a polyoxyethylene oleoketyl ether phosphate, a polyoxyethylene nonylphenyl ether phosphate, a polyoxyethylene nonyl(branched) ether phosphate, or a combination thereof. In one particular embodiment, the anionic surfactant comprises a polyoxyethylene tridecyl ether phosphate.

In one embodiment, the anionic surfactant may comprise about 10 wt. or less, such as about 7.5 wt. % or less, such as about 5 wt. % or less, such as about 3 wt. % or less, such as about 2 wt. % or less, such as about 1 wt. % or less, such as about 0.75 wt. % or less, such as about 0.6 wt. % or less, such as about 0.5 wt. % or less, such as about 0.4 wt. % or less, such as about 0.3 wt. % or less, such as about 0.25 wt. % or less of the composition.

In one embodiment, the anionic surfactant may comprise about 0.001 wt. % or more, such as about 0.005 wt. % or more, such as about 0.01 wt. % or more, such as about 0.05 wt. % or more, such as about 0.1 wt. % or more, such as about 0.125 wt. % or more, such as about 0.15 wt. % or more, such as about 0.175 wt. % or more, such as about 0.2 wt. % or more, such as about 0.25 wt. % or more, such as about 0.3 wt. % or more, such as about 0.4 wt. % or more, such as about 0.5 wt. % or more, such as about 1 wt. % or more of the composition.

D. Wax Agents

In one embodiment, the presently claimed composition may further include a wax agent. The wax agent may be a natural wax such as a petroleum wax (e.g., paraffin wax), a mineral wax (e.g., a montan wax), a vegetable wax (e.g., a carnauba wax), a synthetic wax (e.g., a polyethylene wax), or a combination thereof. In one embodiment, the wax agent comprises a natural wax, a mineral wax, a vegetable wax, or a combination thereof. In one particular embodiment, the wax agent comprises a petroleum wax. In one particular embodiment, the wax agent comprises a vegetable wax. In another particular embodiment, the wax agent comprises a synthetic wax. In one embodiment, the wax agent excludes synthetic waxes.

In one embodiment, the wax agent may comprise a carnauba wax, a paraffin wax, or a combination thereof. In one particular embodiment, the wax agent may comprise a carnauba wax. In one particular embodiment, the wax agent may comprise a paraffin wax. In one embodiment, the wax agent may be provided as a microcrystalline wax. In one embodiment, the wax agent may be provided as a nanoscale wax, such as a nanoscale wax emulsion.

In general, paraffin waxes are natural, petroleum-based waxes which are solid, firm materials that are typically mixtures of saturated straight-chain hydrocarbons obtained from refining waxy distillates derived from paraffinic crude oils. Without intending to be limited, the paraffin waxes may contain an average of 20 carbon atoms or more, such as about 30 carbon atoms or more, such as about 35 carbon atoms or more, such as about 40 carbon atoms or more to about 80 carbon atoms or less, such as about 70 carbon atoms or less, such as about 60 carbon atoms or less, such as about 50 carbon atoms or less, such as about 40 carbon atoms or less per molecule.

In general, carnauba waxes are natural, vegetable-based waxes which typically comprise a mixture of esters of fatty acids and high-molecular weight alcohols and unsaponifiable materials.

In one embodiment, the wax agent may comprise about 40 wt. or less, such as about 30 wt. % or less, such as about 25 wt. % or less, such as about 20 wt. % or less, such as about 15 wt. % or less, such as about 13 wt. % or less, such as about 12 wt. % or less, such as about 11 wt. % or less, such as about 10 wt. % or less, such as about 7.5 wt. % or less, such as about 6 wt. % or less, such as about 5.5 wt. % or less, such as about 5 wt. % or less, such as about 4 wt. % or less, such as about 3 wt. % or less of the composition.

In one embodiment, the wax agent may comprise about 0.5 wt. % or less, such as about 1 wt. % or more, such as about 1.5 wt. % or more, such as about 2 wt. % or more, such as about 2.5 wt. % or more, such as about 3 wt. % or more, such as about 4 wt. % or more, such as about 4.5 wt. % or more, such as about 5 wt. % or more, such as about 7.5 wt. % or more, such as about 9 wt. % or more, such as about 10 wt. % or more, such as about 12.5 wt. % or more, such as about 15 wt. % or more, such as about 17.5 wt. % or more, such as about 20 wt. % or more, such as about 25 wt. % or more of the composition.

E. Binder

In one embodiment, the presently claimed composition may further include a binder. As is generally known in the art, the binder may assist in binding particles to a desired surface, such as a seed surface. Without intending to be limited by theory, such binding may be the result of a physical or chemical binding.

In general, any binder known in the art may be employed. The binder may include a styrene/butadiene copolymer, a butadiene/acrylonitrile copolymer, a styrene/butadiene/acrylonitrile copolymer, a styrene/methacrylic ester copolymer, a vinyl acetate/acrylic copolymer, a vinyl acetate/methacrylic ester copolymer, a vinyl acetate/ethylene copolymer, a vinyl acetate homopolymer, a methacrylic ester/acrylic ester copolymer, etc.

In one particular embodiment, the binder comprises a styrene, butadiene, or a combination thereof. In one particular embodiment, the binder comprises a styrene/butadiene copolymer. In particular, the binder comprises a styrene/butadiene copolymer latex. In one particular embodiment, the binder comprises a carboxylated styrene/butadiene copolymer. In particular, the binder comprises a carboxylated styrene/butadiene copolymer latex.

Other binders may include, but are not limited to, copolymers of methyl vinyl ether with maleic anhydride or monoalkyl esters of maleic anhydride; polyvinylpyrrolidone; copolymers of vinyl pyrrolidone with vinyl acetate; copolymers of vinyl pyrrolidone with vinyl alkyls; polyvinyl acetate; ethylene/vinyl acetate copolymers; vinyl acetate acrylic copolymers; A-B block copolymers of ethylene oxide and propylene oxide; A-B-A triblock copolymers of EO-PO-EO; and polyvinyl alcohol.

In one embodiment, the binder may be a latex binder. For instance, the binder may be in the form of a dispersion or aqueous carrier of polymer particles.

In one embodiment, the binder may comprise about 15 wt. % or less, such as about 10 wt. or less, such as about 7.5 wt. % or less, such as about 6 wt. % or less, such as about 5 wt. % or less, such as about 4 wt. % or less, such as about 3.5 wt. % or less, such as about 3 wt. % or less, such as about 2.5 wt. % or less, such as about 2 wt. % or less, such as about 1.5 wt. % or less, such as about 1.4 wt. % or less, such as about 1.3 wt. % or less, such as about 1 wt. % or less, such as about 0.9 wt. % or less, such as about 0.75 wt. % or less of the composition.

In one embodiment, the binder may comprise about 0.1 wt. % or more, such as about 0.2 wt. % or more, such as about 0.4 wt. % or more, such as about 0.5 wt. % or more, such as about 0.6 wt. % or more, such as about 0.75 wt. % or more, such as about 1 wt. % or more, such as about 1.1 wt. % or more, such as about 1.2 wt. % or more, such as about 1.25 wt. % or more, such as about 1.5 wt. % or more, such as about 1.75 wt. % or more, such as about 1.9 wt. % or more, such as about 2 wt. % or more, such as about 2.5 wt. % or more, such as about 2.75 wt. % or more, such as about 3 wt. % or more, such as about 4 wt. % or more, such as about 5 wt. % or more of the composition.

F. Silicate

In one embodiment, the presently claimed composition may further include a silicate. In general, a silicate is a compound containing an anionic silicon compound. Generally, silicates are clay minerals.

In one embodiment, the silicate comprises a nesosilicate, a sorosilicate, a cyclosilicate, an inosilicate, a phyllosilicate, a tectosilicate, or a combination thereof. In one particular embodiment, the silicate comprises a phyllosilicate. In another particular embodiment, the silicate comprises at least two phyllosilicates. In this regard, in one embodiment, the silicate may be a layered silicate. Accordingly, the silicate may be a platelet-like or particulate like silicate.

In general, examples of suitable silicates include clay minerals (such as kaolin, illite, smectite, montmorillonite, vermiculite, talc, palygorskite, and pyrophyllite) and micas (such as phlogopite, biotite, zinnwaldite, lepidolite, muscovite, gluaconite, and clintonite). In one particular embodiment, the silicate comprises kaolin, talc, mica, or a combination thereof. In another particular embodiment, the silicate comprises kaolin, mica, or a combination thereof. In another particular embodiment, the silicate comprises a combination of kaolin and mica.

In one embodiment, the silicate material may be coated. For instance, in one embodiment, the silicate material may be coated with a metal oxide. In one particular embodiment, the silicate material may be coated with an oxide of titanium, tin, zirconium, chromium, iron, or tungsten. In one particular embodiment, the silicate material may be coated with an oxide of titanium or iron. In one particular embodiment, the silicate material is coated with titanium oxide.

In one particular embodiment, the silicate may comprise a titanium dioxide coated mica. In one particular embodiment, the silicate may comprise kaolin and a titanium dioxide coated mica.

In one embodiment, the silicate may comprise about 40 wt. % or less, such as about 35 wt. % or less, such as about 30 wt. % or less, such as about 27.5 wt. % or less, such as about 25 wt. % or less, such as about 22.5 wt. % or less, such as about 20 wt. % or less, such as about 17.5 wt. % or less, such as about 15 wt. % or less, such as about 12.5 wt. % or less, such as about 10 wt. % or less, such as about 7.5 wt. % or less, such as about 5 wt. % or less, such as about 2.5 wt. % or less of the composition.

In one embodiment, the silicate may comprise about 0.5 wt. % or less, such as about 1 wt. % or more, such as about 1.5 wt. % or more, such as about 2 wt. % or more, such as about 2.5 wt. % or more, such as about 4 wt. % or more, such as about 5 wt. % or more, such as about 7.5 wt. % or more, such as about 10 wt. % or more, such as about 12.5 wt. % or more, such as about 15 wt. % or more, such as about 17.5 wt. % or more, such as about 20 wt. % or more, such as about 25 wt. % or more of the composition.

In one embodiment as mentioned above, the composition may comprise at least two silicates. Each silicate may be present in the aforementioned amounts individually or in combination. In one embodiment, a first silicate may be present in an amount of less than the second silicate. For instance, the first silicate may be present in an amount of about 25 wt. % or less, such as about 40 wt. % or less, such as about 50 wt. % or less, such as about 60 wt. % or less than the amount of the second silicate.

G. Other Components

Even though they may not be expressly mentioned herein, it should be understood that the presently claimed composition may also further comprise other components or additives generally known in the art. These may include other surfactants, sequestering agents, plasticizers, colorants and dyes, brighteners, emulsifiers, flow agents, coalescing agents, defoaming agents, thickeners, fillers, polymers, wetting agents and anti-freezing agents.

It should be understood that such conventional additives may be employed in the composition in amounts generally known in the art. For instance, the additives may be employed in amounts of from about 0.1 wt. % to about 20 wt. %, such as from about 0.5 wt. % to about 10 wt. %.

H. Liquid Medium

The composition may be provided via a liquid medium. For instance, the liquid medium may be aqueous based, organic based, or a combination thereof. In one embodiment, the composition may include at least water.

However, it should be understood that the liquid medium may also include other acceptable organic based media. For instance, the liquid medium may also comprise a polyol. In one embodiment, the liquid medium comprises a glycerol, a glycol, or a combination thereof. In one particular embodiment, the liquid medium comprises glycerol.

In another particular embodiment, the liquid medium comprises a glycol. In particular, the glycol may be an ethylene glycol, a propylene glycol, or a combination thereof. In one particular embodiment, the glycol may be a propylene glycol. In one particular embodiment, the glycol may be an ethylene glycol.

In one embodiment, the liquid medium comprises a combination of water and a glycol. In particular, in one embodiment, the liquid medium comprises a combination of water and a propylene glycol.

In one particular embodiment, at least some of the components employed in the composition are soluble within the liquid medium. In particular, at least some of the components employed in the composition are soluble in water.

In one embodiment, the liquid medium may be present in an amount of about 99 wt. % or less, such as about 98 wt. % or less, such as about 95 wt. % or less, such as about 92.5 wt. % or less, such as about 90 wt. % or less, such as about 85 wt. % or less, such as about 80 wt. % or less, such as about 75 wt. % or less, such as about 70 wt. % or less, such as about 65 wt. % or less, such as about 60 wt. % or less, such as about 50 wt. % or less of the composition.

In one embodiment, the liquid medium may be present in an amount of about 25 wt. % or more, such as about 30 wt. % or more, such as about 35 wt. % or more, such as about 40 wt. % or more, such as about 50 wt. % or more, such as about 60 wt. % or more, such as about 70 wt. % or more, such as about 75 wt. % or more, such as about 80 wt. % or more, such as about 85 wt. % or more of the composition.

When employed, the glycol may be present in an amount less than the water when employed. For instance, the glycol may be present in an amount of about 10 wt. or less, such as about 7.5 wt. % or less, such as about 5 wt. % or less, such as about 4 wt. % or less, such as about 3 wt. % or less, such as about 2.5 wt. % or less, such as about 2 wt. % or less of the composition.

In one embodiment, the glycol may comprise about 0.1 wt. % or more, such as about 0.25 wt. % or more, such as about 0.5 wt. % or more, such as about 0.75 wt. % or more, such as about 1 wt. % or more, such as about 1.5 wt. % or more, such as about 2 wt. % or more, such as about 2.5 wt. % or more, such as about 3 wt. % or more, such as about 4 wt. % or more, such as about 5 wt. % or more of the composition.

I. Stability

The present inventors have discovered that by employing the particular components with the composition as disclosed herein, the composition can provide improved stability of agrochemical active ingredients. In particular, the present inventors have discovered that the amount of components necessary to stabilize the composition can be reduced in comparison to conventional compositions for stabilization.

In general, the stability can be assessed using any method generally known in the art. For instance, in one embodiment, the stability can be assessed by utilizing a wet sieve test. Such test may allow for the determination of the extent of crystallization of some or all of the components within the composition. For instance, the sieve analysis can be employed to assess the particle size distribution of any particulates/precipitates present within the composition.

As disclosed herein, such stability can be assessed in accordance with CIPAC MT 185 and using a 100 mesh size sieve (150 micrometers). When employing such method, the present inventors have discovered that the composition can exhibit 2.4% or less, such as 2.2% or less, such as 2% or less, such as 1.8% or less, such as 1.6% or less, such as 1.5% or less, such as 1.4% or less, such as 1.2% or less, such as 1% or less, such as 0.8% or less, such as 0.6% or less, such as about 0.5% or less or less than 0.5% retention on the sieve. In one embodiment, the composition can exhibit 0.0001 wt. % or more, such as about 0.001 wt. % or more, such as 0.01 wt. % or more, such as 0.06% or more or more than 0.06%, such as 0.08% or more, such as 0.1% or more, such as 0.15% or more, such as 0.2% or more, such as 0.25% or more, such as 0.3% or more, such as 0.4% or more retention on the sieve. In one embodiment, the retention rate may be as disclosed herein and may exclude a retention rate of from 0.055% to 0.060%.

Additionally, stability could be determined on a visual basis. For instance, those formulations that were relatively stable may also exhibit a flowable viscosity, no or minimal sedimentation after 24 hours, and/or no or minimal visible crystal growth.

J. Application

The composition disclosed herein can be utilized according to any method generally known in the art. For instance, in one embodiment, the composition may be employed as a seed coating composition.

Accordingly, in one embodiment, the present disclosure is also directed to a method of coating a seed using the composition as disclosed herein. In general, the coating of the seed can be conducted using any method generally known in the art. For instance, such coating can be performed in a continuous process or in a batch process.

In general, the method may comprise a step of contacting the seed with the composition as disclosed herein. In this regard, the composition can be applied to an exterior surface of the seed thereby allowing any water and/or other volatile components to vaporize. In some embodiments, further drying, such as by employing heat and/or forced air, may be may be necessary.

In one embodiment, the aforementioned method can provide a seed coated with the composition disclosed herein. For instance, the components, such as the binder, can be utilized to assist in binding any active ingredients to the seed. In this regard, the present invention is also directed to a seed coated with the composition and/or components disclosed herein.

In general, the coated seeds can be employed to grow plants, fruits, and/or vegetables. In particular, the seeds may be soybean, corn, wheat, canola, sunflower, alfalfa, edible beans, grains sorghum, turf, forage grass, and peas. In this regard, it should be understood that the seed is not limited to any particular type of seed.

In one embodiment, the composition may be delivered without the incorporation of an active ingredient. However, in this regard, an end user may formulate a composition containing the composition disclosed herein with an active ingredient. When formulated in such manner, the composition disclosed herein may still provide stability to the composition as prepared and delivered and the resulting composition containing any active ingredients.

### EXAMPLES

Compositions were formulated containing the following components: silicate 1, phosphate ester surfactant, silicate 2, paraffin wax, binder, sodium polyacrylate, glycol, and water. The stability of a composition containing all of the aforementioned components in combination with at least one fungicide and at least one colorant was tested. In particular, a wet sieve test in accordance with CIPAC MT 185 and using a 100 mesh size sieve (150 micrometers) was conducted. Thereafter, individual components were removed from the composition and the stability was determined. In a final composition, none of the components were employed.

In the table above, an “X” signifies that the particular component was employed in the composition. Accordingly, if there is no “X”, that signifies that the particular component was not employed in the composition. By preparing formulations in such manner, the effect that such component has on the stability of the composition can be determined.

The results are available in the following table.

| | | Phosphate | | | | | | | Wet Sieve |
|---|---|---|---|---|---|---|---|---|---|
| | | Ester | | Paraffin | | Sodium | | | Residue |
| | Silicate 1 | Surfactant | Silicate 2 | Wax | Binder | Polyacrylate | Glycol | Water | % |
| A | X | X | X | X | X | X | X | X | 0.0024 |
| B | X | X | X | X | X | X | — | X | 0.0873 |
| C | X | X | — | X | X | X | X | X | 0.4771 |
| D | — | X | X | X | X | X | X | X | 0.6965 |
| E | X | X | X | — | X | X | X | X | 3.3227 |
| F | X | X | X | X | X | — | X | X | 3.3655 |
| G | X | — | X | X | X | X | X | X | 4.8707 |
| H | X | X | X | X | — | X | X | X | 5.7724 |
| I | — | — | — | — | — | — | — | — | 2.4521 |

In the following experiments, stability of a composition containing a combination of the aforementioned components with at least one fungicide and at least one colorant was tested. In particular, a wet sieve test in accordance with CIPAC MT 185 and using a 100 mesh size sieve (150 micrometers) was conducted. Thereafter, individual components were removed from the composition and the stability was determined. In a final composition, none of the components were employed.

The results are available in the following table.

| | | Phosphate | | | | | | | | | Wet Sieve |
|---|---|---|---|---|---|---|---|---|---|---|---|
| | | Ester | Paraffin | | Sodium | | | | | | Residue |
| # | Silicate(s) | Surfactant | Wax | Binder | Polyacrylate | Silicone | Isothiazolone | Thickener | Glycol | Water | % |
| 1 | X | 0.50% | 33.00% | X | 2.00% | — | — | — | — | X | 0.0873% |
| 2 | X | 0.50% | 33.00% | X | 2.00% | — | — | — | — | X | 0.8607% |
| 3 | — | 0.50% | 33.00% | X | 2.00% | — | — | — | — | X | 0.5373% |
| 4 | — | 0.50% | 33.00% | — | 2.00% | — | — | — | — | X | 0.3794% |
| 5 | X | 0.50% | 33.00% | — | 2.00% | — | — | — | — | X | 1.0374% |
| 6 | X | 0.50% | — | — | 2.00% | — | — | — | — | X | 3.8285% |
| 7 | X | 0.50% | 33.00% | — | 2.00% | — | — | — | — | X | 2.6756% |
| 8 | X | 0.50% | 33.00% | X | 2.00% | — | — | — | — | X | 3.9373% |
| 9 | X | 0.50% | 33.00% | X | 2.00% | — | — | — | X | X | 0.0024% |
| 10 | X | 0.50% | 33.00% | X | 2.00% | — | — | — | — | X | 3.6174% |
| 11 | X | — | 33.00% | X | 2.00% | — | — | — | X | X | 4.8707% |
| 12 | X | — | 33.00% | | 2.00% | — | — | — | X | X | 1.3716% |
| 13 | X | 0.50% | 33.00% | X | 2.00% | — | — | — | X | X | 0.9695% |
| 14 | X | 0.50% | 33.00% | X | 2.00% | — | — | — | X | X | 0.4771% |
| 15 | X | 0.50% | — | X | 2.00% | — | — | — | X | X | 3.3227% |
| 16 | X | 0.50% | 33.00% | — | 2.00% | — | — | — | X | X | 5.7724% |
| 17 | X | 0.50% | 33.00% | X | — | — | — | — | X | X | 3.3655% |
| 18 | X | 0.50% | 33.00% | X | 2.00% | X | X | X | X | X | 0.0581% |
| 19 | — | — | — | — | — | — | — | — | — | — | 2.4521% |
| 20 | — | — | 33.00% | — | 2.00% | — | — | — | — | X | 0.4444% |
| 21 | — | 0.50% | — | — | 2.00% | — | — | — | — | X | 0.2986% |
| 22 | — | 0.50% | 33.00% | — | — | — | — | — | — | X | 0.1655% |

In the table above, the phosphate ester surfactant component contains about 98 wt. % of the surfactant, the paraffin wax component contains about 31.5-32.5 wt. % of the wax, and the sodium polyacrylate component contains about 20-25 wt. % of the sodium polyacrylate.

These and other modifications and variations to the present invention may be practiced by those of ordinary skill in the art, without departing from the spirit and scope of the present invention, which is more particularly set forth in the appended claims. In addition, it should be understood that aspects of the various embodiments may be interchanged both in whole or in part.

Furthermore, those of ordinary skill in the art will appreciate that the foregoing description is by way of example only, and is not intended to limit the invention so further described in such appended claims.

1. A composition for stabilizing at least one active ingredient, the composition comprising:
at least one agrochemically active ingredient; and
at least two of the following:
a polycarboxylic acid polymer or a salt thereof,
an anionic surfactant,
a wax agent, and
wherein the composition has a retention of 2.4% or less when conducting a wet sieve analysis in accordance with CIPAC MT 185 and using a 100 mesh size sieve.

2. The composition of claim 1, wherein the composition comprises a polycarboxylic acid polymer or a salt thereof and an anionic surfactant.

3. The composition of claim 1, wherein the composition comprises a polycarboxylic acid polymer or a salt thereof and a wax agent.

4. The composition of claim 1, wherein the composition comprises an anionic surfactant and a wax agent.

5. The composition of claim 1, wherein the composition has a retention of 2% or less when conducting a wet sieve analysis in accordance with CIPAC MT 185 and using a 100 mesh size sieve.

6. The composition of claim 1, wherein the composition has a retention of 1% or less when conducting a wet sieve analysis in accordance with CIPAC MT 185 and using a 100 mesh size sieve.

7. The composition of claim 1, wherein the wherein the composition has a retention of 0.5% or less when conducting a wet sieve analysis in accordance with CIPAC MT 185 and using a 100 mesh size sieve.

8. The composition of claim 1, wherein the composition further comprises at least two active ingredients.

9. The composition of claim 8, wherein the active ingredient comprises at least one fungicide.

10. The composition of claim 9, wherein the active ingredient comprises at least two fungicides.

11. The composition of claim 1, wherein the active ingredient comprises prothioconazole, metalaxyl, fluoxastrobin, or any combination thereof.

12. The composition of claim 11, wherein the active ingredient comprises any two of prothioconazole, metalaxyl, fluoxastrobin, or any combination thereof.

13. The composition of claim 12, wherein the active ingredient comprises prothioconazole and metalaxyl.

14. The composition of claim 1, wherein the active ingredient comprises prothioconazole.

15. The composition of claim 1, wherein the active ingredient comprises metalaxyl.

16. The composition of claim 1, wherein the polycarboxylic acid polymer or a salt thereof comprises a polyacrylic acid polymer or a salt thereof.

17. The composition of claim 1, wherein the polycarboxylic acid polymer or a salt thereof comprises a polyacrylate.

18. The composition of claim 1, wherein the polycarboxylic acid polymer or a salt thereof comprises an alkali metal.

19. The composition of claim 1, wherein the polycarboxylic acid polymer or a salt thereof comprises a sodium polyacrylate.

20. The composition of claim 1, wherein the anionic surfactant comprises a sulfonate, a sulfate ester, a phosphate surfactant, a sulfosuccinic acid derivative, an ether carboxylate, a fatty acid derivative, or a combination thereof.

21. The composition of claim 1, wherein the anionic surfactant comprises a phosphate ester surfactant.

22. The composition of claim 1, wherein the anionic surfactant comprises an ethoxylated alkyl ester phosphate.

23. The composition of claim 1, wherein the wax agent comprises a paraffin wax, a carnauba wax, or a combination thereof.

24. The composition of claim 1, wherein the wax agent comprises a paraffin wax.

25. The composition of claim 1, wherein the composition further comprises a binder.

26. The composition of claim 25, wherein the binder comprises a styrene/butadiene copolymer, a butadiene/acrylonitrile copolymer, a styrene/butadiene/acrylonitrile copolymer, a styrene/methacrylic ester copolymer, a vinyl acetate/acrylic copolymer, a vinyl acetate/methacrylic ester copolymer, a vinyl acetate/ethylene copolymer, a vinyl acetate homopolymer, a methacrylic ester/acrylic ester copolymer, or a combination thereof.

27. The composition of claim 25, wherein the binder comprises a styrene/butadiene copolymer.

28. The composition of claim 1, wherein the composition further comprises a silicate.

29. The composition of claim 28, wherein the silicate comprises kaolin, talc, mica, or a combination thereof.

30. The composition of claim 28, wherein the silicate comprises kaolin and talc.

31. The composition claim 29 or 30, wherein the talc is coated with a metal oxide.

32. The composition of claim 1, wherein the composition further comprises a liquid medium.

33. The composition of claim 32, wherein the liquid medium comprises water.

34. The composition of claim 32, wherein the liquid medium comprises a glycol.

35. The composition of claim 32, wherein the liquid medium comprises water and a propylene glycol.

36. A method of coating a seed, the method comprising contacting the seed with the composition of claim 1.

37. A coated seed formed according to the method of claim 36.
